(19) United States
(12) Patent Application Publication
(10) Pub. No.: US 2016/0217222 A1
(43) Pub. Date: Jul. 28, 2016

(54) Package Testing

(71) Applicant: AXIOM CONSULTING PRIVATE LIMITED, Bangalore (IN)

(72) Inventors: Chandrasekhar Jagannath Arcot, Bangalore (IN); Lakshminarayana Giridhar, Bangalore (IN); Satya Simha Rao, Bangalore (IN)

(73) Assignee: Axiom Consulting Private Limited, Bangalore (IN)

(21) Appl. No.: 14/915,917

(22) PCT Filed: Sep. 2, 2014
(86) PCT No.: PCT/IB2014/064191

§ 371 Date: Mar. 2, 2016

(30) Foreign Application Priority Data
Sep. 2, 2013 (IN) 3916/CHE/2013

(51) Int. Cl. G06F 17/50; G06N 3/04

(52) U.S. Cl. CPC G06F 17/50; G06N 3/04

(57) ABSTRACT

The present subject matter discloses systems and methods for managing patents in an enterprise. In one implementation, the method includes, performing one or more tests simulation on a package utilizing a plurality of tests environments and input data. Further, the method includes, evaluating the package based an evaluation criterion to identify a safe package, wherein the evaluation criterion includes a pass/fail criteria.

### DESCRIPTION OF THE INVENTION

The following specification particularly describes the invention and the manner in which it is to be performed:

### TECHNICAL FIELD

The present subject matter relates, in general, to testing and, in particular, to systems and methods for package testing.

### BACKGROUND

Generally, packaging is the science, art, and technology of enclosing or protecting products for distribution, storage, sale, and use. In addition, packaging also refers to the process of design, evaluation, and production of packages. In other words packaging may also be described as a coordinated system of preparing goods for transport, warehousing, logistics, sale, and end use. Packaging contains, protects, preserves, transports, informs, and sells.

Typically, corrugated fiberboard sometimes known as corrugated board or corrugated cardboard, which is a combined paper-based material consisting of one or more plys of a fluted corrugated medium and one or two flat linerboards, is used for packaging goods. Such corrugated fiberboard typically designed and formed in to boxes for packaging goods. Corrugated boxes are used frequently as shipping containers. Corrugated boxes provide some measure of product protection by themselves but often require inner components such as cushioning, bracing and blocking to help protect fragile contents.

Corrugated box design and testing is the process of matching design factors for corrugated fiberboard boxes with the functional physical, processing and end-use requirements and then testing the same for durability. Generally, engineers work to meet the performance requirements of a box while controlling total costs.

### SUMMARY

This summary is provided to introduce concepts related to systems and methods of package testing and the concepts are further described below in the detailed description. This summary is neither intended to identify essential features of the claimed subject matter nor is it intended for use in determining or limiting the scope of the claimed subject ratter.

In one implementation, the method includes, performing one or more tests simulation on a package utilizing a plurality of tests environments and input data. Further, the method includes, evaluating the package based an evaluation criterion to identify a safe package, wherein the evaluation criterion includes a pass/fail criteria.

### BRIEF DESCRIPTIONS OF DRAWINGS

The detailed description is described with reference to the accompanying drawings. In the figures, the left-most digit(s) of a reference number identifies the drawing in which the reference number first appears. The same numbers are used throughout the drawings to reference like/similar features and components.

FIG. 1 illustrates a network environment implementing a package testing system, according to an embodiment of the present subject matter.

FIG. 2 illustrates the package testing system, according to an embodiment of the present subject matter.

FIG. 3 illustrates an exemplary method of package testing, according to an embodiment of the present subject matter.

### DETAILED DESCRIPTION

System and method for package testing are described herein. The system and method for package testing can be implemented in variety of computing systems. Examples of such computing system include but are not restricted to High Performance Computing (HPC) main frame computers, workstation, personal computers, desktop computers minicomputers, servers, multiprocessor system, laptop, network server and the like.

As discussed, packaging is the science, art, and technology of enclosing or protecting products for distribution, storage, sale, and use. Further, packaging is classified in to primary packaging, secondary packaging and tertiary packaging. Primary packaging is that which surrounds a product when sold to a final consumer. Primary packaging is most often seen by the consumer and that of which they are most conscious. Primary packaging is also in direct contact with the product which adds complexity in terms of food safety requirements, hygiene requirements, etc. Primary packaging also includes packaging material that is included with the primary pack, such as a label on a jar, a cardboard sleeve on a tray, or a lid on a bottle.

Secondary or grouped packaging is that which is used to collate primary units for ease of handling in the selling environment. Typically this packaging can be corrugated cardboard boxes or trays, containing a number of primary units. Variations include shelf ready packaging which can be placed directly on a shelf in a supermarket for a consumer to pick from, or carry-out packaging such as a cardboard carry out case for multiple bottles of wine so that the consumer can carry the pack away. Tertiary or transport packaging is that which is used to facilitate handling and transport of a number of secondary packs in order to prevent handling and transport damage. Typically this packaging can be pallets, stretch-wrap plastic film or shrink-wrapped plastic hoods. This type of packaging could also include additional items such as cardboard corner guards, layer pads or pallet caps.

Package development involves considerations for sustainability, environmental responsibility, and applicable environmental and recycling regulations. It may involve a life cycle assessment which considers the material and energy inputs and outputs to the package, the packaged product, the packaging process, the logistics system, waste management, etc. It is necessary to know the relevant regulatory requirements for point of manufacture, sale, and use. In order for packaging to be optimized, primary, secondary and tertiary packaging must be considered as a total packaging system. Reducing one type of packaging is futile if a corresponding increase is required in another. For example, reducing the thickness of a primary plastic tub is meaningless if the secondary cases that the tubs are packed in need to be strengthened to prevent the tubs from being crushed.

Package design and testing is an integral part of the new product development process. In some cases, development of a package may be a separate process, but is linked closely with the product to be packaged. Package design starts with the identification of all the requirements, for example, structural design, marketing, shelf life, quality assurance, logistics, legal, regulatory, graphic design, end-use, environmental, etc. Further, multiple package designs developed. Computer-aided design, and computer-aided manufacturing, conventional rapid prototyping methodology for prototyping each of the designs. Further, the various prototypes are physically tested for sustainability. Subsequently, based on the results, amendments are done in the initial designs. Furthermore, the new prototypes are developed utilizing the amended designs and again physically tested. This conventional design, prototyping, and testing cycle are repeated over a number of times to reach an optimal packaging design. Such conventional cycle for packaging development utilizes a high amount resources and time. Thus, resulting to increased cost and wastage of material.

In another conventional package design process each package is individually designed, such as all the primary packages, secondary packages, and all tertiary packages utilizing any computer-aided design. Further, these individual designs are tested using the finite element analysis process. Subsequently, based on the results, primary package, secondary package and tertiary package is optimized. But as described, packaging is a complete system individual optimization does not result in to complete packaging optimization. Furthermore, this conventional package design necessitates systems with high computing capabilities and substantial time to compute. In the initial stage due to numerous variations of package designs this conventional package design process is slow and costly.

In accordance with the present subject matter, a method and system for package testing is described. In the said implementation, input data is obtained. The input data includes package design, material models, boundary conditions, test parameters, historical data. The package design includes primary package design, secondary package design, and tertiary package design. Material models include the material properties, strength properties, other characteristics of the package. Boundary conditions include the environmental conditions for example, humidity, temperature, pressure. Tests parameters include the testing criteria, for example, the drop height for performing the drop test, vibration profile for the vibration tests etc. Historical data includes previous package design tests and their results.

Further, utilizing the boundary conditions and test parameters a plurality of tests conditions and tests environments are generated. In an example, the test environment may be a drop test consisting of a drop from a height of 2 meters on a leading edge of a single ply corrugated cardboard box, containing six bottles of shampoo in room of 100% humidity with room temperature of 30° C. at pressure of 1 bar.

In the said implementation, test simulations utilizing the plurality of test sceneries and input data are performed. In an example artificial neural network (ANN) may be utilized to perform the tests simulations. The utilization of ANN reduces the time required for tests simulations. The tests are performed in a predetermined order on the same cardboard box. During the test simulations process residual strains retained at the end of each test are recorded and are transferred in to the subsequent test.

Further, utilizing the residual stress recorded and a predefined evaluation criterion the package designs may be classified multiple categories. For example the categories may include very safe, marginally safe, marginally unsafe, and very unsafe.

In accordance to the present subject matter, the system and method for package testing reduces the number of cycles of packaging design by evaluating and identifying safe package designs, from a vast pool of design combinations of primary, secondary and tertiary packaging, which may be further optimized. Further, the total time required for computation is reduced. Furthermore, prototyping and physical testing is only performed of the final optimal design for validation, thus reducing wastage of resources. Thus there is a overall reduction in the cost of package design and testing. These and other features along with the advantages of the present subject matter will be further evident in the subsequent detailed description in conjunction with the figures.

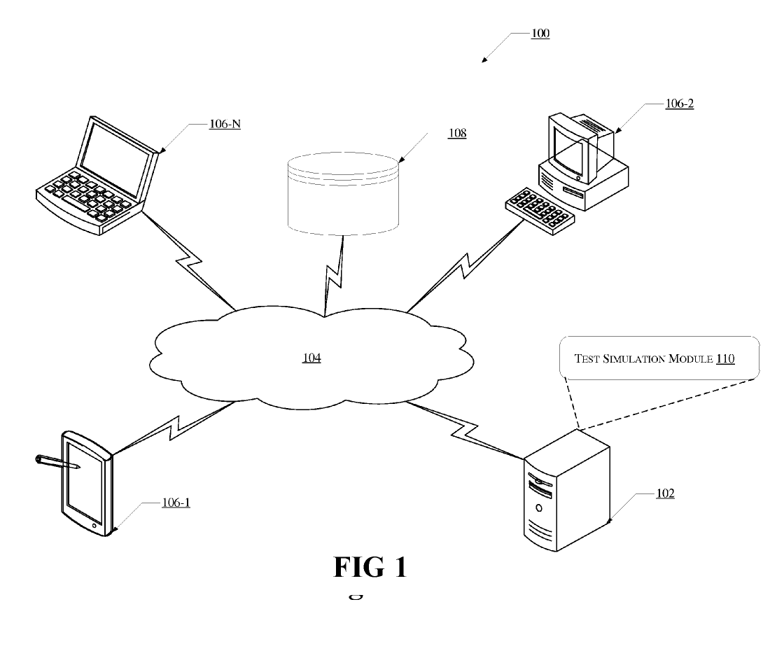

FIG. 1 illustrates a network environment 100 implementing a package testing system 102, according to an implementation of the present subject matter. In the said implementation, the network environment 100 includes the package testing system 102, herein after referred as the system 102, configured to perform virtual package testing for evaluation of package designs. In another implementation, the system 102 may be included in an already implemented information technology system or any package design system.

The system 102 may be implemented in a variety of computing system, such as laptop computer, a desktop computer, a notebook and the like. Further, the system 102 may be communicatively coupled to user devices 106-1, 106-2 . . . , 106-N, collectively referred to as device(s) 106. For example, the devices 106 may include, but not limited to a desktop computer, a mobile phone, a handheld device, a workstation, and a laptop computer. In another implementation the system 102 may be implemented inside the device 106. Moreover, the devices 106 individually may be located in geographically distant location from each other as well as the system 102.

In another implementation, the devices 106 and the system 102 may be communicatively coupled through a network 104. The network 104 may be a wireless network, wired network or a combination thereof. The network 106 can be implemented as one of the different types of network such as intranet, local area network (LAN), wide area network (WAN), the internet and such. The network may either be a dedicated network or a shared network, which represents an association of the different types of network that use a variety of protocol for example, Hypertext Transfer Protocol (HTTP), Transmission Control Protocol/Internet Protocol (TCP/IP), Wireless Application Protocol (WAP) for communication. Further, the network 104 may include a variety of network devices, including but not limiting to routers bridges, servers, computing devices, storage devise. For maintaining readability adhering to the subject matter of the present invention, the variety of network devices have not been described. It may be understood that the network may include all the various network devices, as known to a person skilled in the art.

In the implementation a database 108 is communicatively coupled directly to the system 102 or through the network 104. The database 108 may be located in a geographically similar location or in a geographically distinct location as the system 102 or any of the devices 106. In another implementation the database may be located internally to the system 102 or the device 102 or a combination thereof. The database 108 may store or provided access historical data and physical data.

In accordance with the present subject matter, the system 102 is configured to perform testing of packaging designs and evaluating the packaging design. In the said implementation, the system 102 obtains input data. In an example, the input may be provided from by the user via the device 106. In another example the system may obtain the input data from the database 108. The input data includes package design, material models, boundary conditions, test parameters, historical data. The package design includes primary package design, secondary package design, and tertiary package design. Material models include the material properties, strength properties, other characteristics of the package. Boundary conditions include the environmental conditions for example, humidity, temperature, pressure. Tests parameters include the testing criteria, for example, the drop height for performing the drop test, vibration profile for the vibration tests etc. Historical data includes previous package design tests and their results.

Further, the system 102 is configured to generate test environment the boundary conditions and test parameters. In an implementation the test environment may be real time by the system 102. In another implementation, the system may be configured to generate tests and store in database 108. Further, during package testing the system 102 may be configured to obtain the previously generated tests data for package testing.

Subsequently, the system 102 is configured to perform test simulations utilizing the plurality of test sceneries and input data. The tests simulation may be performed in a random order or in a predefined order. In an example artificial neural network may be utilized. In another example, closed function method may utilized. Further, the system 102 is configured the simulation data. In one implementation the residual stress at the end of each test may be recorded. In one more implementation residual strain, geometric changes or any known may be recorded.

In addition, the system 102 may be configured to evaluate the package designs tests utilizing the recorded data and predefined evaluation criteria. In an implementation the package designs may be classified in a multiple categories based on the recorded data and the predefined evaluation criteria for example safe package design and unsafe package design. In one other implementation any one of a percentage of safety, a damage coefficient, a probability of failure utilizing the recorded simulation data. Further, the package design may be organized in a increasing or decreasing order. Furthermore, the system may be configured to provide an indication on the changes that may be performed on the current package design to obtain an optimal package design.

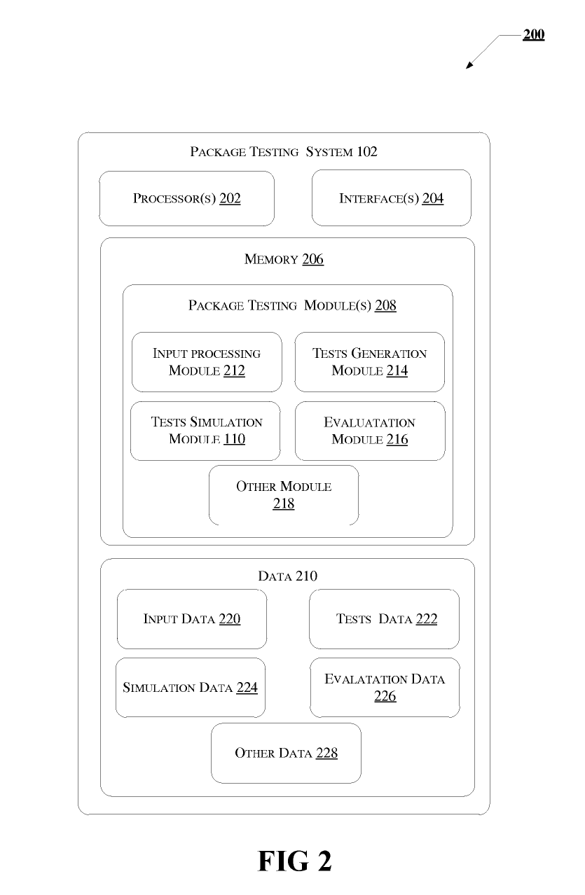

FIG. 2 illustrates the exemplary components of the package testing system 102, according to an embodiment of the present subject matter. In one embodiment, the package testing system 102 includes a processor(s) 202, interface(s) 204, a memory 206 coupled to the processor(s) 202, and a data 208 coupled to the processor(s) 202.

The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 is configured to fetch and execute computer-readable instructions stored in the memory 206.

The interface(s) 204 may include a variety of software and hardware interfaces, for example, a web interface, a graphical user interface, etc., allowing the package testing system 102 to interact with the user devices 104. Further, the interface(s) 204 may enable the package testing system 102 to communicate with other computing devices, such as web servers and external data servers (not shown in figure). The interface(s) 204 can facilitate multiple communications within a wide variety of networks and protocol types, including wired networks, for example LAN, cable, etc., and wireless networks such as WLAN, cellular, or satellite. The interface(s) 204 may include one or more ports for connecting a number of devices to each other or to another server.

The memory 206 can include any computer-readable medium known in the art including, for example, volatile memory, for example, Random Access Memory (RAM), and/or non-volatile memory, for example, Erasable Programmable Read Only Memory (EPROM), flash memory. In one embodiment, the memory 206 includes module(s) 108.

In one implementation, the modules 208 further include an input processing module 212, a test generation module 214, a test simulation module 110, and evaluation module 216. The modules 208 may also include other modules 218 for providing various other functionalities of the package testing system 102. It will be appreciated by any person skilled in the art, that such modules may be represented as a single module or a combination of different modules.

The data 210 serves, amongst other things, as a repository for storing data fetched, processed, received and generated by one or more of the modules 208. In one implementation, the data 210 may include input data 220, test data 222, simulation data 224, evaluation data 226 and other data 238. In one embodiment, the data 210 may be stored in the memory 206 in the form of data structures. Additionally, the aforementioned data can be organized using data models, such as relational or hierarchical data models.

In an example, a shampoo manufacturing company intends to revamp its shampoo bottles with new designs. Keeping this objective in mind, the shampoo manufacturing company develops multiple package designs. Further, the shampoo manufacturing company may utilize the system 102 to perform a plurality of tests on the package designs and evaluate the developed package designs.

In an implementation, the input processing module 212 is configured to obtain input data. The input data includes package design, material models, boundary conditions, test parameters, tests details, and historical data. The package design includes primary package design, secondary package design, and tertiary package design. Material models include material properties, strength properties, and other characteristics of the package. Boundary conditions include environmental conditions for example, humidity, temperature, and pressure. Tests parameters include the testing criteria, for example, the drop height for performing the drop test, vibration profile for the vibration tests etc. Test details included the total number of tests, order of tests, and type of tests. Historical data includes previous package design tests and their results. In addition, the input processing module 212 is configured to store the input data in the input data 220.

In the described example of the shampoo manufacturing company, the input processing module 212 is configured to obtain input data. The input data includes package designs, test parameters, material models, tests details, and historical data. The package design included cad models of the primary package, secondary package and tertiary package. Material model includes the material model of the shampoo container, and the corrugated cardboard sheet used for secondary and tertiary packaging. Tests details include number tests=2, type of tests-drop tests, vibration tests, order of test-first drop tests and then vibration tests. Tests parameters include drop height of 5 meters, and vibration profile. The input processing module 212 is further configured to store the input data in the input data 220.

Further to the said implementation, tests generation module 214 is configured to generate test environments based on the input data. The tests environments may be described as the physical tests to be performed in a real world environment. In other words, the tests environments mimic the real world condition any package may undergo during it life cycle. In an implementation, the generation of test environment by tests generation module 214 may be real time. In another implementation, the tests environments may be generated by tests generation module 214 beforehand and stored in the database 108 and may be obtained by the tests generation module 214 when required. The test generation module is further, configured to store the tests environment in the tests data 214.

In the said example of shampoo manufacturing company, tests generation module 214 is configured to generate test environments based on the input data. The tests environment includes a drop tests environment and a vibration tests environment. The drop tests environment generated is a drop from a height of 5 meters on the leading edge of the package designs in an environment of 60% humidity. The vibration tests environment generated is a vibration of the packaging in a vibration profile of high intensity in humidity of 80% and pressure 1 bar.

Furthermore, the tests simulation module 110 is configured to obtain the generated tests environments and perform tests simulations. The tests simulations may be described as performing the tests utilizing the test environment in a predefined order. During the tests simulations tests simulation module 110 is configured to compute a coefficient of damage at the end of each tests and transfer it to the next tests. The coefficient of damage is indicative of the damage sustained by the package design at the end of each test. The coefficient of damage improves the relation between the tests performed by effectively creating a link between the previous tests and the next test. This effectively recreates the real world conditions of a package undergoing multiple loads and effects while continuously sustaining damage. The test simulation module 224 is configured to store the test simulation results and the coefficient of damage to simulation data 224. In an implementation artificial neural network may be utilized for tests simulations. In an example, the following pseudo code may be

In the said example of shampoo manufacturing company, the tests simulation module 110 obtains the drop tests environment and vibration tests environment, and performs the tests simulations. The tests simulation module 110 performs the drop test on the package designs and computes a coefficient of damage oat the end of the tests. Further, tests simulation module 110 performs the vibration tests utilizing the coefficient of damage computed at the end of the drop tests and the vibration tests environment. Furthermore, coefficient of damage at the end of the vibration tests is computed. In addition the tests simulation module 110 stores the simulation data in simulation data 224.

In in the example artificial neural network may be utilized to perfrom tests simulations. A neural network (NN), in the case of artificial neurons is called artificial neural network (ANN) or simulated neural network (SNN), is an interconnected group of natural or artificial neurons that uses a mathematical or computational model for information processing based on a connectionist approach to computation. Typically, an ANN is an adaptive system that changes its structure based on external or internal information that flows through the network. In an example, the following pseudo code for ANN may be utilized.

```
      // Read Data (section heading)
      Read no. of input variables from training set
      Read no. of output variables from training set
      // Design Neural Networks (section heading)
      Initialize no. of input nodes = no. of input variables
      Initialize no. of hidden nodes = approx. (1.2 * no. of input
      variables)
      Initialize no. of hidden layers = 1
      Initialize no. of output nodes = no. of output variables
      Initialize threshold for all nodes = 1
      Initialize weight for all connectors = 1
      Select activation function
      // Loop through training cycles (section heading)
      While (Cycle error > error specified)
        Do (for each of training data point)
          Calculate the outputs from inputs using neural network
          Calculate the thresholds and weights using back propagation
          Calculate the error between first and recomputed results
          Use gradient descent method to reduce error
          Set recomputed results as previous results
        End Do
        Calculate Cycle error
End While
      //Report results (section heading)
```

According in the said implementation, the evaluation module 216 is configured evaluate the package design utilizing the simulation data and predefined evaluation criterion. Further, a safe design may be identified based on the evaluation. In an example, the evaluation may be in the form of a pass fail output. In another example it may be in the form of percentage safety or probability of failure. Furthermore, the evaluation module 216 is configuring to store the evaluation results in the evaluation data 226. In an implementation, based on the simulation data the evaluation module 216 may be configured to recommend the changes to be performed to optimize the package design.

In the said example of shampoo manufacturing company, the evaluation module 216 obtains the simulation data and the coefficient of damage at the end of drop tests and the vibration test. Further the evaluation module computes probability of failure of all the package designs. Utilizing the simulation data and the probability of failure and a predefined elevation criterion the evaluation module 216 evaluates the package in to safe designs and unsafe designs. Further, the evaluation module 216 suggests percentage change or design change to be performed on the package designs for optimization. Thus, in accordance with the present subject matter package testing and evaluation of multiple package designs is enabled.

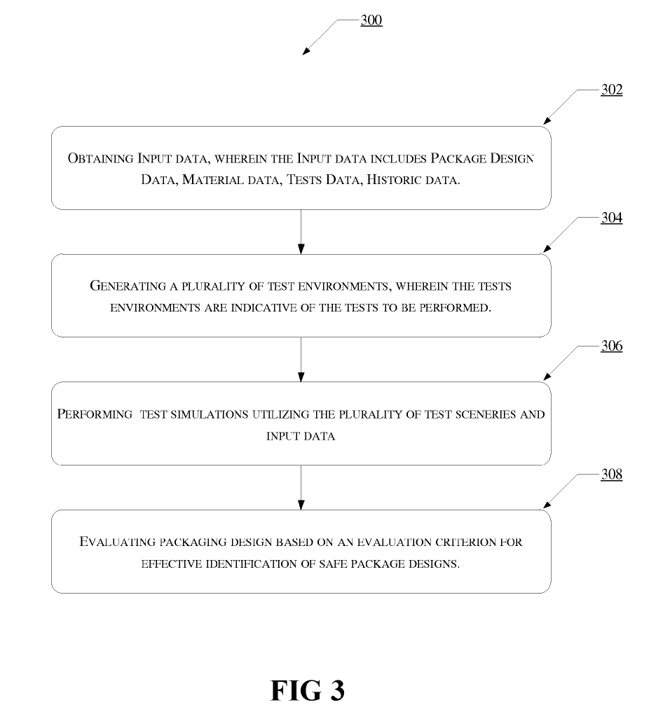

FIG. 3 illustrates an exemplary method 300 for generating a material model, according to an embodiment of the present subject matter. The method 300 may be described in the general context of computer executable instructions. Generally, computer executable instructions can include routines, programs, objects, components, data structures, procedures, functions, and modules, which perform particular functions or implement particular abstract data types. The method 300 may also be practiced in a distributed computing environment where functions are performed by remote processing devices that are linked through a communication network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300, or alternative methods. Additionally, individual blocks may be deleted from the method 300 without departing from the spirit and scope of the subject matter described herein. Furthermore, the method 300 can be implemented in any suitable hardware, software, firmware, or combination thereof.

With reference to method 300 as depicted in FIG. 3, as shown in block 302, input data is obtained. The input data includes Package Design Data, Material data, Tests Data, Historic data.

As depicted in block 304, a plurality of tests environments are generated. For example the tests environment may include a drop tests, a vibration tests, and a crush test. The tests environment indicative of the real world environment and the conditions a package may undergo during its life cycle. In other example, the tests environment mimics the condition any package may undergo during the course of its life in to tests conditions. For example, a condition of box falling from a height is converted in drop test.

As shown in block 306, test simulations are performed based on the plurality of test environments and input data. For example, the simulation of the package design may be dropped from a height of 5 meters to perform drop tests and subjected a force of 5 N to perform crush tests.

As illustrated in block 308, package design evaluated utilizing a evaluation criterion for evaluation of safe package design. In an example, the evaluation criteria is indicative of the safety of the package. A package may be said to be safe if it does not fail at the end of all the tests. In an example, the evaluation criterion may include pass/fail criteria for identification.

In the present document, the words “exemplary, embodiment, implementation” are used to mean “serving as an example, instance or illustration”. Any embodiment or implementation or example is not to be constructed as preferred or advantages over other embodiment.

We claim:

1. A method for package testing and identification, the method comprising:
performing one or more tests simulation on a plurality of package designs utilizing a plurality of tests environments and input data, wherein the tests environments are indicative of real world conditions and tests to be performed; and
evaluating the package design based an evaluation criterion, wherein the evaluation criterion is indicative of the safety of the package.

2. The method as claimed in claim 1, wherein the method further comprises obtaining the input data, wherein the input data includes the package designs, material models, boundary conditions, test parameters, tests details, and historical data.

3. The method as claimed in claim 1, wherein the method further comprises generating the plurality of tests environments utilizing the input data.

4. The method as claimed in claim 1, wherein the performing further includes
computing a coefficient of damage at the end of each of the one or more tests simulation; and
transferring the coefficient of damage to the subsequent one or more tests simulation.

5. The method as claimed in claim 1, wherein the evaluation criterion further includes a probability of failure of the package.

6. The method as claimed in claim 1, wherein the method further comprises suggesting percentage change or design change to be performed on the package designs for optimization.

7. The method as claimed in claim 1, wherein the one or more tests simulation are preformed utilizing on artificial neural network.

8. A package testing and identification system (102), the system comprising:
a processor (202); and
a memory (206) coupled to the processor (202), the memory (206) comprising:
a tests simulation module (110), wherein the tests simulation module (110) is configured to perform one or more tests simulation on a package design utilizing a plurality of tests environments and input data; and
an evaluation module (216), wherein the evaluation module (216) is configured to evaluate the package design based an evaluation criterion, wherein the evaluation criterion indicative of the safety of the package.

9. The package testing and identification system (102), as claimed in claim 8, further comprising:
an input processing module (212), wherein the input processing module (212) is configured to obtaining the input data, wherein the input data includes the package design, material models, boundary conditions, test parameters, tests details, and historical data; and
a tests generation module (214), wherein the tests generation module (214) is configured to generate the plurality of tests environments utilizing the input data, wherein tests environments are indicative of real world conditions and tests to be performed.

10. The package testing and identification system (102) as claimed in claim 8 wherein the evaluation module (216) is further configured to
compute a coefficient of damage at the end of each of the one or more tests simulation; and
transfer the coefficient of damage to the subsequent one or more tests simulation.

11. The package testing and identification system (102) as claimed in claim 8 wherein the evaluation module (216) is further configured to suggest percentage change or design change to be performed on the package design for optimization.

12. The package testing and identification system (102) as claimed in claim 8, wherein the tests simulation module (110) utilizes an artificial neural network for one or more test simulation.

13. A non-transitory machine-readable medium having embodied thereon a machine readable instruction for executing a method for package testing and identification, the method comprising:
obtaining the input data, wherein the input data includes package designs, material models, boundary conditions, test parameters, tests details, and historical data;
generating the plurality of tests environments utilizing the input data;
wherein the tests environments are indicative of real world conditions and tests to be performed;
performing one or more tests simulation on a package utilizing a plurality of tests environments and input data; and
evaluating the package based an evaluation criterion to identify a safe package, wherein the evaluation criterion includes a pass/fail criteria.
